(19) United States
(12) Patent Application Publication
(10) Pub. No.: US 2024/0356184 A1
(43) Pub. Date: Oct. 24, 2024

(54) Pouch Type Secondary Battery, Secondary Battery Module Including the Same, and Pouch for Use Therein

(71) Applicant: LG Energy Solution, Ltd., Seoul (KR)

(72) Inventors: Yong Joon Choi, Daejeon (KR); Soo Youl Kim, Daejeon (KR); Dong Su Lee, Daejeon (KR)

(73) Assignee: LG Energy Solution, Ltd., Seoul (KR)

(21) Appl. No.: 18/686,310

(22) PCT Filed: Oct. 14, 2022
(86) PCT No.: PCT/KR2022/015600

§ 371 Date: Feb. 23, 2024

(30) Foreign Application Priority Data
Oct. 14, 2021 (KR) 10-2021-0136975
Oct. 12, 2022 (KR) 10-2022-0130928

(51) Int. Cl. H01M 50/588; H01M 50/105; H01M 50/121; H01M 50/178

(52) U.S. Cl. CPC H01M 50/588; H01M 50/105; H01M 50/121; H01M 50/178

(57) ABSTRACT

The present invention relates to a pouch type secondary battery with improved insulation performance, a secondary battery module including the same, and a pouch therefor.

The pouch type secondary battery has a pouch that includes: an accommodation part in which the electrode assembly is accommodated and an edge part disposed along an outer circumference of the accommodation part to define an edge. The edge part includes an insulating layer having an insulating material, and, in the insulating layer, a first insulating layer and a second insulating layer are stacked in sequence from an inside toward an outside of the pouch.

### CROSS-REFERENCE TO RELATED APPLICATION

The present application is a national phase entry under 35 U.S.C. § 371 of International Application No. PCT/KR2022/015600 filed on Oct. 14, 2022, which claims the benefit of the priority of Korean Patent Application Nos. 10-2021-0136975, filed on Oct. 14, 2021, and 10-2022-0130928, filed on Oct. 12, 2022, which are hereby incorporated by reference in their entirety.

### TECHNICAL FIELD

The present disclosure relates to a pouch type secondary battery, a secondary battery module including the same, and a pouch for use therein, and more particularly, to a pouch type secondary battery with improved insulation performance, a secondary battery module including the same, and a pouch for use therein.

### BACKGROUND ART

Batteries (cells) that generate electrical energy through a physical reaction or a chemical reaction of a substance to supply power to the outside are used when AC power to be supplied to a building is not obtained or DC power is required, according to living environments surrounded by various electronic devices.

Among such batteries, primary batteries and secondary batteries that are chemical batteries using the chemical reaction are generally used a lot. The primary batteries are consumable batteries that are collectively referred to as dry batteries. The secondary batteries are rechargeable batteries that are manufactured using a material in which a redox process between a current and a substance is repeatable several times. When a reduction reaction is performed on the material by the current, power is charged, and when an oxidation reaction is performed on the material, power is discharged. Such a charging-discharging is repeatedly performed to generate electricity.

In recent market, attention has been paid to a pouch type secondary battery 1 having a small volume and a high degree of freedom in design. In more detail, as illustrated in FIG. 1a, the pouch type secondary battery 1 may include an electrode assembly 1a including a positive electrode/separator/negative electrode, a pouch 1b in which the electrode assembly 1a is accommodated, and an electrode lead 1c electrically to connected the positive electrode/negative electrode of the outside of the electrode assembly 1a and protruding from the outside of the pouch 1b. Here, a lead film 1c′ made of an insulating material may be attached to each of both surfaces of the electrode lead 1c.

Here, the pouch 1b is constituted generally by a stack of various thin functional films. As a representative example, the pouch 1b may have a structure in which an inner insulating layer 1ba for isolation of internal components of the pouch 1b, a metal layer 1bc that maintains mechanical strength of the pouch 1b, and an outer insulating layer 1bb that insulates the metal layer 1bc from an external component, are stacked in sequence from the inside toward the outside, as illustrated in FIG. 1b.

However, the pouch type secondary battery 1 having such a structure has problems that as the metal layer 1bc is exposed to the outside at a side surface of an edge of the pouch 1b, a leakage current occurs to degrade performance of the secondary battery. In particular, there is a problem that due to failure to secure a sufficient separation distance for insulation between the metal layer 1bc exposed to the outside and the electrode lead 1c, an arc occurs during applying an external voltage to cause damage (e.g., burn mark) to the secondary battery 10 (1) (see FIG. 1c).

When the pouch type secondary battery 1 having the structure as described above is used to provide one secondary battery module, insulation between the metal layer 1bc of the pouch type secondary battery 1 and a module housing (not shown) made of a metal material is required. Thus, there is a problem of requiring an additional insulation design, for example, the pouch type secondary battery 1 is disposed apart from the module housing or a structure made of an insulating material is inserted between the pouch type secondary battery 1 and the module housing.

### DISCLOSURE OF THE INVENTION

### Technical Problem

The present invention has been devised to solve the problems as above and an object of the present invention is to provide a pouch type secondary battery with improved insulation performance, a secondary battery module including the same, and a pouch for use therein.

### Technical Solution

The present invention may provide a pouch type secondary battery including an electrode assembly, which includes an electrode and a separator, and a pouch in which the electrode assembly is embedded. The pouch type secondary battery is characterized in that the pouch includes: an accommodation part in which the electrode assembly is accommodated; and an edge part disposed along an outer circumference of the accommodation part to define an edge, wherein the edge part includes an insulating layer having an insulating material, and, in the insulating layer, a first insulating layer and a second insulating layer are stacked in sequence from the inside toward the outside.

The pouch type secondary battery may include an electrode lead connected to the electrode and protruding from the pouch toward the outside, and the insulating layer may be disposed at a position corresponding to the electrode lead.

The electrode lead may protrude from at least one end of the pouch toward the outside, and the insulating layer may be disposed at the end of the pouch, from which the electrode lead protrudes.

The insulating layer may be disposed so as to surround the electrode lead.

A lead film made of an insulating material may be attached to each of both surfaces of the electrode lead, and the insulating layer may be disposed so as to surround the lead film.

In the pouch, a difference between a width of the insulating layer and a width of the lead film may be equal to or greater than a difference between the width of the lead film and a width of the electrode lead.

In the pouch, a spaced distance between one end of the insulating layer and one end of the lead film may be equal to or greater than a thickness of the lead film.

The electrode lead may protrude from one end of the pouch in one direction.

The electrode lead may protrude from each of both ends of the pouch in an opposite direction to another.

At least one of the first insulating layer or the second insulating layer may have a synthetic resin material.

The first insulating layer may include polypropylene (PP).

The second insulating layer may include polyethylene terephthalate (PET).

The present invention may provide a pouch characterized by including: an accommodation part in which an empty space is defined; and an edge part disposed along an outer circumference of the accommodation part to define an edge, wherein the edge part includes an insulating layer having an insulating material, and, in the insulating layer, a first insulating layer and a second insulating layer are stacked in sequence from the inside toward the outside.

The present invention may provide a secondary battery module including a plurality of pouch type secondary batteries described above.

The present invention may provide a pouch sealing method for sealing an edge of a pouch in which an electrode assembly including an electrode and a separator is embedded. The pouch sealing method is characterized by including: a first sealing step of sealing an insulating layer having an insulating material at the edge; and a second sealing step of sealing a portion excluding the insulating layer from the edge, wherein a sealing temperature in the second sealing step is higher than a sealing temperature in the first sealing step.

### Advantageous Effects

The pouch type secondary battery according to the present invention, the secondary battery module including the same, and the pouch for use therein may include the insulating layer in the edge part to have the effect that the insulation performance of the secondary battery may be improved.

The pouch type secondary battery according to the present invention, the secondary battery module including the same, and the pouch for use therein may include the insulating layer disposed at the position corresponding to the electrode lead to have the effect that the sufficient insulation distance between the electrode lead the metal layer, which constitutes the pouch, may be secured to increase the insulation performance of the secondary battery.

Moreover, the pouch type secondary battery according to the present invention, the secondary battery module including the same, and the pouch for use therein may include the insulating layer in the edge part to have the effect that the design for the insulation between the module housing and the secondary battery may be omitted during the manufacture of the secondary battery module to reduce the manufacture cost and the manufacture time.

### BRIEF DESCRIPTION OF THE DRAWINGS

FIG. 1a is a front view illustrating a pouch type secondary battery according to the related art.

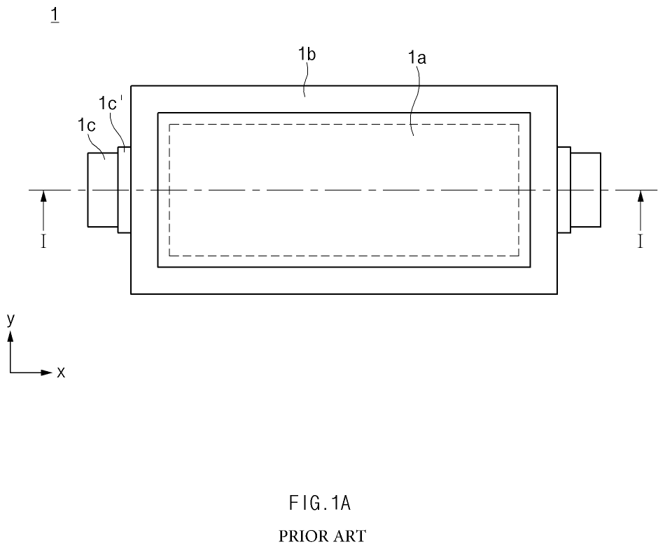

FIG. 1b is a cross-sectional view illustrating a cross section of the pouch type secondary battery in a direction I-I in FIG. 1a.

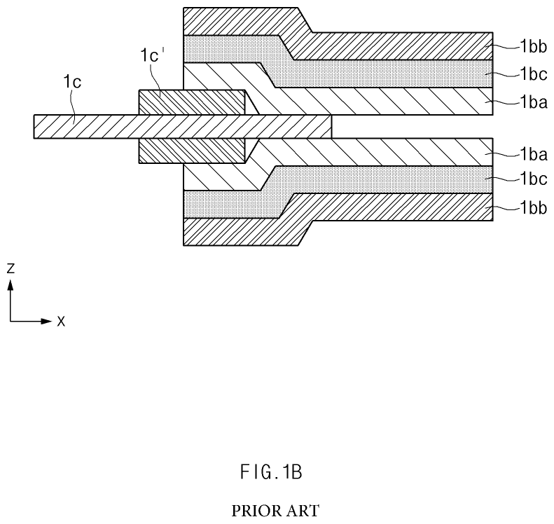

FIG. 1c is an image showing damage of a partial region of a secondary battery in the pouch type secondary battery in FIG. 1a.

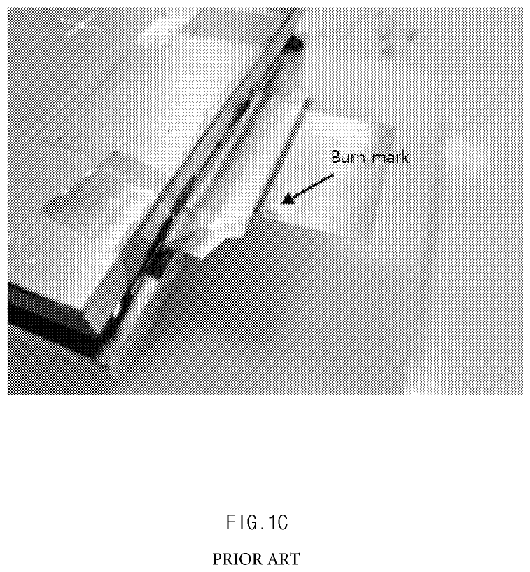

FIG. 2 is a front view illustrating a pouch type secondary battery according to the present invention.

FIG. 3 is a cross-sectional view illustrating a cross section of the pouch type secondary battery in a direction II-II in FIG. 2.

FIG. 4 is a cross-sectional view illustrating a cross section of the pouch type secondary battery in a direction III-III in FIG. 2.

### MODE FOR CARRYING OUT THE INVENTION

Hereinafter, preferred embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. Like reference numerals refer to like elements throughout the whole specification.

### Pouch Type Secondary Battery

The present invention provides a pouch type secondary battery 10 including an electrode assembly 100 which includes an electrode and a separator, and a pouch 200 in which the electrode assembly 100 is embedded. The pouch type secondary battery 10 is characterized in that the pouch 200 includes an accommodation part 210 in which the electrode assembly 100 is accommodated, and an edge part 220 disposed along the outer circumference of the accommodation part 210 to define an edge, the edge part 220 includes an insulating layer 221 having an insulating material, and, in the insulating layer 221, a first insulating layer 221a and a second insulating layer 221b are stacked in sequence from the inside toward the outside.

The electrode assembly 100 is a component, which includes the electrode (not shown) and the separator (not shown), and may have various configurations.

In more detail, the electrode assembly 100 may include the electrode including a positive electrode and a negative electrode, and the separator interposed between the electrodes. Here, the positive electrode may be provided by coating an electrode collector with a positive electrode active material, and the negative electrode may be provided by coating an electrode collector with a negative electrode active material.

Such an electrode assembly 100 may be provided as a stacked type electrode assembly, in which a separator is interposed between a positive electrode and a negative electrode, a jelly-roll type electrode assembly, a stacked/folded type electrode assembly combining the stacked type and the jelly-roll type, or the like.

An electrode lead 300 that may be electrically connected to another secondary battery or an external device may be connected to each of the positive electrode and the negative electrode described above.

The electrode lead 300 is a component, which is connected to the electrode and protrudes from the pouch 200 to be described later toward the outside, and may have various configurations.

In more detail, the electrode lead 300 may have one end that is connected to electrode tabs (not shown) provided in the electrode, and the other end that protrudes to the outside of the pouch 200 to be connected to the other secondary battery or the external device. Accordingly, the electrode lead 300 may electrically connect the electrode assembly 100 accommodated inside the pouch 200 to the other secondary battery or the external device outside the pouch 200.

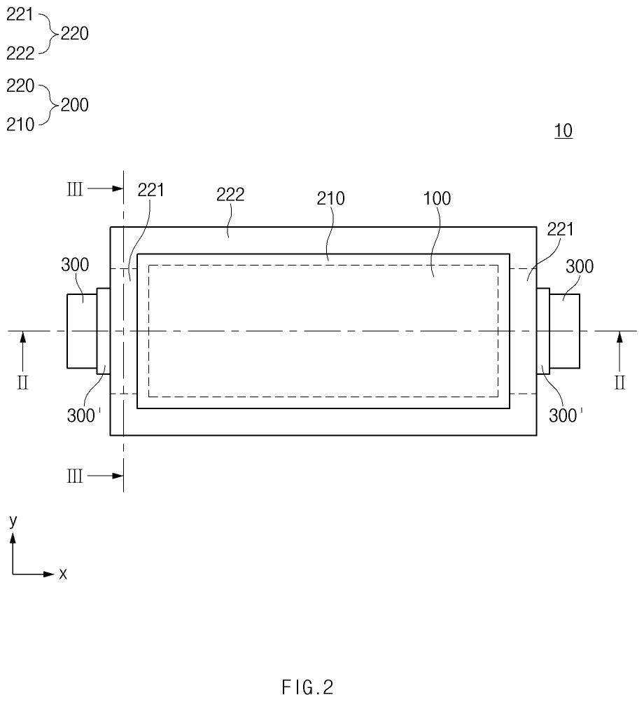

Here, the electrode lead 300 may protrude from at least one end of the pouch 200 toward the outside. In one example, the electrode lead 300 may protrude from one end of the pouch 200 in one direction. In another example, the electrode lead 300 may protrude from each of both ends of the pouch 200 in an opposite direction to another (see FIG. 2).

A material having electrical conductivity may be used as the material of the electrode lead 300 without being particularly limited. For example, the material of the electrode lead 300 may include at least one of copper (Cu), aluminum (Al), nickel (Ni), iron (Fe), carbon (C), chromium (Cr), or manganese (Mn). However, the material of the electrode lead 300 is not limited to the foregoing materials, and may be variously selected in consideration of mechanical strength, flexibility, processability, and so on.

In the electrode lead 300, a lead film 300′ made of an insulating material may be additionally attached to each of both sides of the electrode lead 300 in order to increase sealability of the pouch 200 and sufficiently secure electrical isolation.

The pouch 200 is a component, in which the electrode assembly 100 described above is embedded, and may have various configurations.

Specifically, the electrode assembly 100 may be accommodated in the pouch 200, and a region surrounding the region in which the electrode assembly 100 is accommodated may be sealed to physically or chemically protect the electrode assembly 100 from the outside.

Such a pouch 200 may include the accommodation part 210, in which the electrode assembly 100 is accommodated, and the edge part 220 disposed along the outer circumference of the accommodation part 210 to define the edge.

Here, the accommodation part 210 is a component of the pouch 200, in which the electrode assembly 100 is accommodated, and may have various configurations.

For example, any region is available as the accommodation part 210 as long as having an inner empty space defined so as to accommodate the electrode assembly 100. Not only the electrode assembly 100 but also an electrolyte, etc., may be accommodated in the inner empty space.

The accommodation part 210 may include a metal layer 210c so as to protect internal components such as the electrode assembly 100 and the electrolyte, to complement the electrochemical properties by the electrode assembly 100 and the electrolyte, to improve heat resistance, and so on. The accommodation part 210 may include a first insulating layer 210a and a second insulating layer 210b, each of which is made of an insulating material, for electrical isolation between the metal layer 210c and internal and external components of the pouch 200.

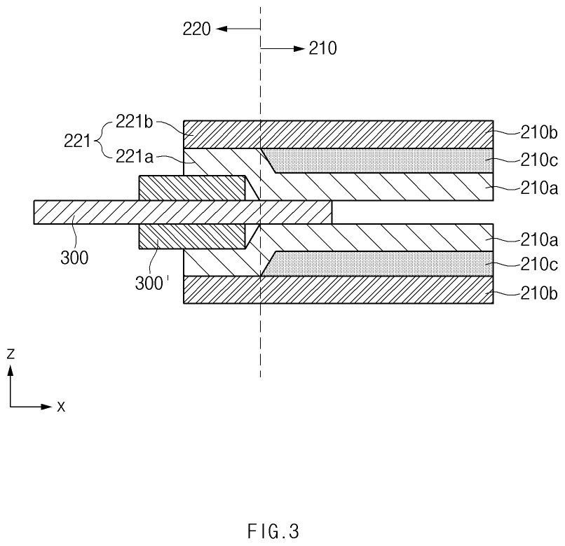

Here, the first insulating layer 210a, the metal layer 210c, and the second insulating layer 210b may be stacked in sequence from the inside toward the outside of the pouch 200 as illustrated in FIG. 3.

Here, polypropylene (PP) may be used in the first insulating layer 210a, polyethylene terephthalate (PET) may be used in the second insulating layer 210b, and aluminum (Al) or the like may be used in the metal layer 210c. However, the materials of the first insulating layer 210a, the second insulating layer 210b, and the metal layer 210c are not limited thereto, and may be used without being particularly limited as long as the first insulating layer 210a and the second insulating layer 210b each have an insulating material and the metal layer 210c has a metal material.

The edge part 220 is a component, which is disposed along the outer circumference of the accommodation part 210 to define an edge, and may have various configurations.

Specifically, as illustrated in FIG. 2, the edge part 220 may be disposed so as to surround the accommodation part 210 at the outer circumference of the accommodation part 210 of the pouch 200, and define an edge portion of the pouch 200. Here, the edge part 220 may be integrated with the accommodation part 210. Here, in terms of the structure of the pouch 200, a side surface of the edge part 22, which is disposed in a direction opposite to a direction facing the accommodation part 210, may be exposed to the outside.

The edge part 220 may be sealed so as to physically or chemically protect the electrode assembly 100, which is accommodated in the accommodation part 210 as described above, from the outside. For example, when the pouch 200 includes an upper pouch and a lower pouch, the edge part 220 may be sealed by being heated and compressed in a state in which the upper pouch and the lower pouch overlap each other.

Like the accommodation part 210 described above, the edge part 220 may have a structure in which layers made of different materials are stacked. Here, the edge part 220 may include the insulating layer 221 having an insulating material so as to improve the insulation performance of the pouch type secondary battery 10.

In more detail, the insulating layer 221 is a component, in which the first insulating layer 221a and the second insulating layer 221b are stacked in sequence from the inside toward the outside, and may have various configurations.

Here, any material may be available as the first insulating layer 221a and the second insulating layer 221b as long as the any material is a material having insulation properties.

For example, at least one of the first insulating layer 221a and the second insulating layer 221b may have a synthetic resin material. Here, the first insulating layer 221a may include polypropylene (PP), and the second insulating layer 221b may include polyethylene terephthalate (PET). However, the materials of the first insulating layer 221a and the second insulating layer 221b are not limited thereto, and a material having insulation properties may be used for the first insulating layer 221a and the second insulating layer 221b without being particularly limited.

The insulating layer 221 may be formed in the edge part 220 in various methods. For example, the insulating layer 221 may be formed in a specific region of the edge part 220, or formed in an entire region of the edge part 220.

Here, when the insulating layer 221 is formed in the specific region of the edge part 220, the insulating layer 221 may be provided in any region of the edge part 220. Here, the insulating layer 221 may be formed at a position corresponding to the electrode lead 300 so as to secure a maximum electrical separation distance of the electrode lead 300 having a metal material.

In more detail, as the electrode lead 300 protrudes at least one end of the pouch 200 toward the outside as described above, the insulating layer 221 may be formed at an end of the pouch 200, from which the electrode lead 300 protrudes, as illustrated in FIG. 2.

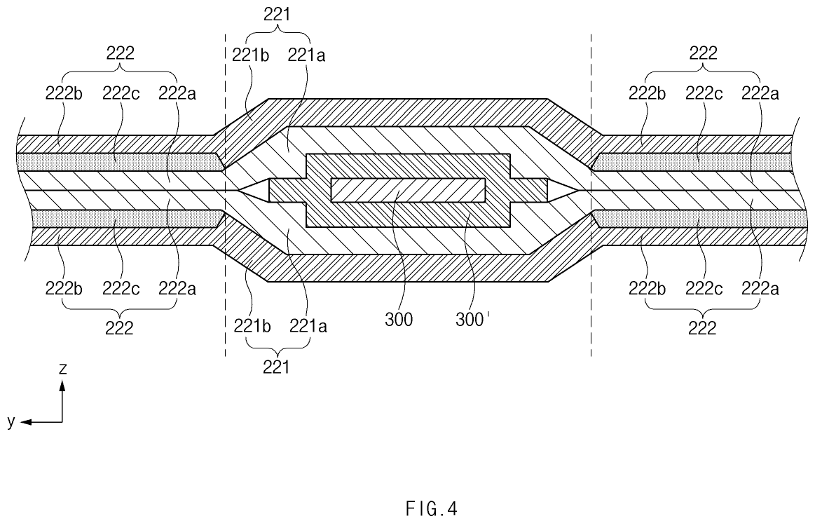

Here, the insulating layer 221 may be disposed so as to surround the electrode lead 300 at the end of the pouch 200. That is, as illustrated in FIGS. 3 and 4, the insulating layer 221 may be formed in a region of the edge part 220, which is provided to face the electrode lead 300, and thus disposed so as to surround the electrode lead 300. Here, when the lead film 300′ made of an insulating material is attached to each of the both surfaces of the electrode lead 300, the insulating layer 221 may be also disposed so as to surround the lead film 300′.

In regard to the arrangement of the insulating layer 221, a preferred difference between the width of the insulating layer 221 and the width of the lead film 300′ may be equal to or greater than a difference between the width of the lead film 300′ and the width of the electrode lead 300. Here, the width may be a width in a Y-axis direction in FIG. 2.

A preferred spaced distance between one end of the insulating layer 221 and one end of the lead film 300′ may be equal to or greater than the thickness of the lead film 300′. Here, the one end of the insulating layer 221 may be the leftmost portion of the insulating layer 221 in FIG. 3, and the one end of the lead film 300′ may be the leftmost portion of the lead film 300′ in FIG. 3.

The preferred arrangement relationship between the insulating layer 221 and the lead film 300′ described above may be an arrangement relationship to stably exhibit the insulation performance necessary for the insulating layer 221 and the lead film 300′.

When the insulating layer 221 is formed only in the specific region, the edge part 220 may further include a coating layer 222 disposed in a region other than the specific region in which the insulating layer 221 is formed.

Here, the coating layer 222 is a component, which is formed in a region other than the specific region in which the insulating layer 221 is formed, and may have various configurations. For example, the coating layer 222 may be provided adjacent to the insulating layer 221, and may be disposed alternately with the insulating layer 221 to constitute the edge part 220.

As illustrated in FIG. 4, the coating layer 222 may have a structure in which a first insulating layer 222a, a metal layer 222c, and a second insulating layer 222b are stacked in sequence from the inside toward the outside.

Here, polypropylene (PP) may be used in the first insulating layer 222a, polyethylene terephthalate (PET) may be used in the second insulating layer 222b, and aluminum (Al) or the like may be used in the metal layer 222c. However, the materials of the first insulating layer 222a, the second insulating layer 222b, and the metal layer 222c are not limited thereto, and may be used without being particularly limited as long as the first insulating layer 222a and the second insulating layer 222b each are an insulating material and the metal layer 222c is a metal material.

The edge part 220 may be sealed as described above. In regard to a sealing method of the edge part 220, when the edge part 220 includes the insulating layer 221 and the coating layer 222, the sealing method may include two steps.

Specifically, the sealing method may include a first sealing step of sealing the insulating layer 221 having an insulating material in the edge part 220, and a second sealing step of sealing the coating layer 222 in the edge part 220. Here, the coating layer 222 may be a portion excluding the insulating layer 221 from the edge part 220.

A sealing temperature in the second sealing step may be higher than a sealing temperature in the first sealing step. In this regard, while the insulating layer 221 includes the first insulating layer 221a and the second insulating layer 221b, the coating layer 222 may further include, in addition to the first insulating layer 222a and the second insulating layer 222b, the metal layer 222c disposed therebetween. Thus, a temperature higher than that of the insulating layer 221 may be required in order to seal the coating layer 222.

The sealing method described above is just one preferred example, and the insulating layer 221 and the coating layer 222 may be sealed by one step.

In the contents described above, the components denoted as different reference numerals but called the same name may be components integrated with each other. That is, the first insulating layer 210a included in the accommodation part 210, the first insulating layer 221a included in the insulating layer 221 of the edge part 220, and the first insulating layer 222a included in the coating layer 222, may be integrated with one another. The second insulating layer 210b included in the accommodation part 210, the second insulating layer 221b included in the insulating layer 221 of the edge part 220, and the second insulating layer 222b included in the coating layer 222, may be integrated with one another. The metal layer 210c included in the accommodation part 210, and the metal layer 222c included in the coating layer 222 of the edge part 220, may be integrated with each other.

### Secondary Battery Module

The present invention may provide a secondary battery module (not shown) including a plurality of pouch type secondary batteries 10 described above. Here, the description of the pouch type secondary batteries 10 is displaced with the contents described above.

Specifically, the plurality of pouch type secondary batteries 10 may be accommodated in a module housing (not shown) in which a spaced is defined. Here, the pouch type secondary batteries 10 according to the present invention do not require an additional insulation design for isolation between the module housing and the secondary batteries and thus, has advantages that a manufacture time and manufacture cost for the secondary battery module may be reduced.

### Pouch

The present invention may provide a pouch 200 including an accommodation part 210, in which an empty space is defined, and an edge part 220 which is disposed along the outer circumference of the accommodation part 210 to define an edge. The pouch 200 is characterized in that the edge part 220 includes an insulating layer 221 having an insulating material, and, in the insulating layer 221, a first insulating layer 221a and a second insulating layer 221b are stacked in sequence from the inside toward the outside. Here, the detailed description of the pouch 200 may be displaced with the description of the pouch 200 of the pouch type secondary battery 10 described above.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

Although the present invention has been described with reference to the limited embodiments and drawings, the present invention is not limited thereto and may be variously implemented by those of ordinary skill in the art to which the present invention pertains, within the technical idea of the present invention and an equivalent of the appended claims.

### DESCRIPTION OF THE SYMBOLS

10: Pouch type secondary battery
100: Electrode assembly
200: Pouch
210: Accommodation part
210a: First insulating layer
210b: Second insulating layer
210c: Metal layer
220: Edge part
221: Insulating layer
221a: First insulating layer
221b: Second insulating layer
221c: Metal layer
222: Coating layer
222a: First insulating layer
222b: Second insulating layer
222c: Metal layer
300: Electrode lead
300′: Lead film

1. A pouch type secondary battery comprising an electrode assembly, which comprises an electrode and a separator, and a pouch in which the electrode assembly is embedded,
wherein the pouch comprises:
an accommodation part in which the electrode assembly is accommodated; and
an edge part disposed along an outer circumference of the accommodation part to define an edge,
wherein the edge part comprises an insulating layer having an insulating material,
wherein, in the insulating layer, a first insulating layer and a second insulating layer are stacked in sequence from an inside toward an outside of the pouch.

2. The pouch type secondary battery of claim 1, further comprising an electrode lead connected to the electrode and protruding from the pouch toward the outside,
wherein the insulating layer is disposed at a position corresponding to the electrode lead.

3. The pouch type secondary battery of claim 2, wherein the electrode lead protrudes from at least one end of the pouch toward the outside, and
the insulating layer is disposed at the at least one end of the pouch, from which the electrode lead protrudes.

4. The pouch type secondary battery of claim 2, wherein the insulating layer is disposed so as to surround the electrode lead.

5. The pouch type secondary battery of claim 2, wherein a lead film made of an insulating material is attached to each of both surfaces of the electrode lead, and
the insulating layer is disposed so as to surround the lead film.

6. The pouch type secondary battery of claim 5, wherein a difference between a width of the insulating layer and a width of the lead film is equal to or greater than a difference between the width of the lead film and a width of the electrode lead.

7. The pouch type secondary battery of claim 5, wherein a spaced distance between one end of the insulating layer and one end of the lead film is equal to or greater than a thickness of the lead film.

8. The pouch type secondary battery of claim 2, wherein the electrode lead includes first and second electrode leads and the first and second electrode leads protrudes from one end of the pouch in one direction.

9. The pouch type secondary battery of claim 2, wherein the electrode lead includes first and second electrode leads and the first and second electrode leads protrudes from each of both ends of the pouch in an opposite directions to another.

10. The pouch type secondary battery of claim 1, wherein at least one of the first insulating layer or the second insulating layer has a synthetic resin material.

11. The pouch type secondary battery of claim 10, wherein the first insulating layer comprises polypropylene (PP).

12. The pouch type secondary battery of claim 10, wherein the second insulating layer comprises polyethylene terephthalate (PET).

13. A pouch comprising:
an accommodation part in which an empty space is defined; and
an edge part disposed along an outer circumference of the accommodation part to define an edge,
wherein the edge part comprises an insulating layer having an insulating material,
wherein, in the insulating layer, a first insulating layer and a second insulating layer are stacked in sequence from an inside toward an outside of the pouch.

14. A secondary battery module comprising a plurality of pouch type secondary batteries according to claim 1.

15. A pouch sealing method for sealing an edge of a pouch in which an electrode assembly comprising an electrode and a separator is embedded, the pouch sealing method comprising:
a first sealing step of sealing an insulating layer having an insulating material at the edge; and
a second sealing step of sealing a portion excluding the insulating layer from the edge,
wherein a sealing temperature in the second sealing step is higher than a sealing temperature in the first sealing step.
